(19) United States
(12) Patent Application Publication
(10) Pub. No.: US 2006/0283072 A1
(43) Pub. Date: Dec. 21, 2006

(54) Device and method for baiting fish hooks

(76) Inventors: Neal Mitchell, Danville, CA (US); John Willing, Danville, CA (US)

Correspondence Address: Harris Zimmerman;Law Offices of Harris Zimmerman, Suite 710, 1330 Broadway, Oakland, CA, 94612, US

(21) Appl. No.: 11/155,704

(22) Filed: Jun. 17, 2005

(51) Int. Cl. A01K 97/00; A01K 97/06

(52) U.S. Cl. 43/4; 43/57.2

(57) ABSTRACT

A device and method for baiting a hook with bait, such as a worm. The device is a band engageable body with a rod extending from one end. The distal end of the rod has a hook engaging notch and the other end of the body has a leader engaging notch. In use, a hook is placed in the rod notch, and tension is applied to the leader to secure the hook in place and the leader is placed in said leader engaging notch to maintain such tension. Bait is then forced over the entire hook to generally encapsulate the same. Tension on the leader is released and the encapsulated hook is removed from the hook notch.

### CROSS-REFERENCE TO RELATED APPLICATIONS

Not applicable.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to fishing equipment, and more particularly to devices for assisting in the placement of bait, such as worms, over a fish hook in such a manner that the bait substantially completely covers and hides the hook from visual recognition by a fish.

2. Description of Related Art

Aside from the casting of nets, typical fishing generally requires placing live or artificial bait on or adjacent a hook to hopefully cause a fish to bite on the bait and be impaled on the barb or barbs formed on the hook. Artificial bait is relatively easy to handle, but in many situations, live bait, such as worms, is preferred. The bait should effectively camouflage or hide the hook from visual recognition by the fish.

This creates a problem in attempting to properly place a slippery, almost viscous bait, such as a worm on the hook. Frequently, the baiting takes place under conditions which are not ideal. The fisherperson may be loaded up with fishing tackle, the weather may be nasty, the baiting may be attempted in a rocking boat, the fisherperson's hands may be cold and wet, etc.

The prior art teaches various aids to facilitate placing worms or the like on hooks, but, in general, such aids have required threading a worm axially onto a hook or some intermediary member; contributed to injuring the person by having the hook barb engage the person's hand; and generally have not made it easy for the person to bait the hook.

### BRIEF SUMMARY OF THE INVENTION

The present invention describes a simple device, with no moving parts, and a method, which enables a person to quickly and safely place live bait onto a hook, even under adverse weather conditions. The invention also results in the bait generally encapsulating the entire hook, so that a fish will only visually observe the bait, rather than the hook. The device of this invention is compact, can be carried in the pocket of a garment worn by the user, and preferably is capable of floating if accidentally dropped in the water. The device also may be colored with luminescent or florescent paint so as to be readily visible, even if thrown into a tackle box or the like.

### BRIEF DESCRIPTION OF THE DRAWINGS

FIG. 1 is a perspective view of the device of the invention.

FIG. 2 is a top plan view of the device.

FIG. 3 is a cross-sectional view taken along the line 3-3 of FIG. 2.

FIG. 4 is an enlarged view of a designated portion of FIG. 3.

FIG. 5 is a partial schematic representation of a knife cutting appropriate lengths of a worm.

FIG. 6 is a perspective view of the device with a hook, leader, and line ready to be positioned on the device.

FIG. 7 is a view similar to FIG. 6, but with the hook and leader operatively positioned on the device.

FIG. 8 illustrates how a length of a worm is placed on the hook.

FIG. 9 shows the hook with a length of worm encapsulating the same.

FIG. 10 is a cross-sectional view of the hook and worm taken in the plane indicated by line 10-10 of FIG. 9.

### DETAILED DESCRIPTION OF THE INVENTION

Both the device and method for baiting a hook will now be described in connection with the accompanying drawings.

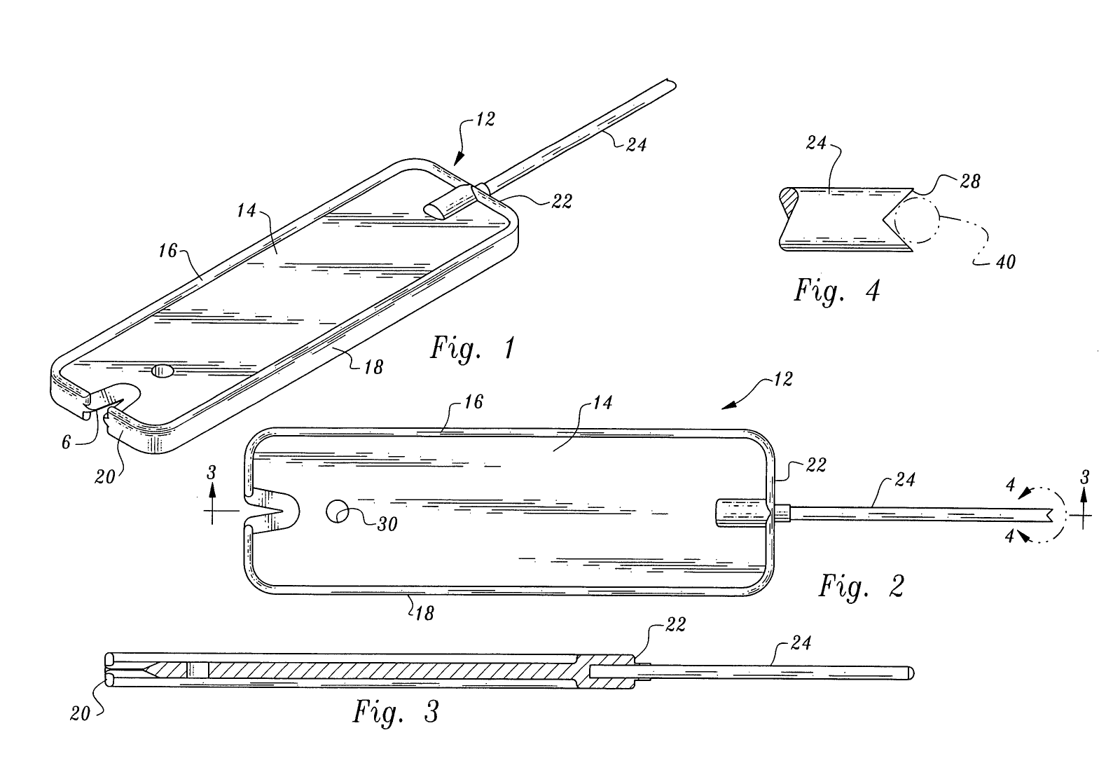

With specific reference to FIGS. 1-3 of the drawings, the device 12 comprises a relatively flat rectangular body portion 14 having longitudinally extending edges 16 and 18, a rear edge 20, and a front edge 22. Extending forwardly from a medial portion of front edge 22 is a rod 24 molded in or otherwise attached to body portion 14. By way of example rather than limitation, body portion 14 may be approximately four inches long, one and one-quarter inch wide, and one-quarter inch thick. These dimensions permit the unit to be easily manually grasped by the user, as will be later explained, while permitting it to be placed in a pocket of a garment worn by the user. The rod 24 may be approximately two inches long, with a diameter of approximately one-tenth of an inch.

The body portion 14 is preferably formed of plastic, while the rod 24 is preferably formed of stainless steel. The dimensions and the materials used are desirably those which permits the device to float in water if accidentally dropped by the user. Also, the plastic selected should have a bright color so as to be visible to the user if dropped in the water or if mixed in a tackle box with a variety of miscellaneous fishing gear. Although the device is illustrated as rectangular, it could be of other configurations so long as the body portion can be conveniently grasped by one hand of the user, while the other hand of the user performs the actual baiting steps.

To complete the description of the device 12, the rear end portion of the body 14 is provided with a notch 26 generally medially of the side edges 16 and 18 of the body. The distal or forward end of rod 24 is likewise provided with a notch 28. Notch 26 could be provided on one of the side edges, but, in practice, its position on the rear edge seems more effective. Also, if desired, but not essential to its operation, the body 14 may be provided with one or more apertures 30 which can be used to attach a tether line (not shown) extending through the aperture for releasable attachment to a garment worn by the user so as to prevent accidentally losing the device.

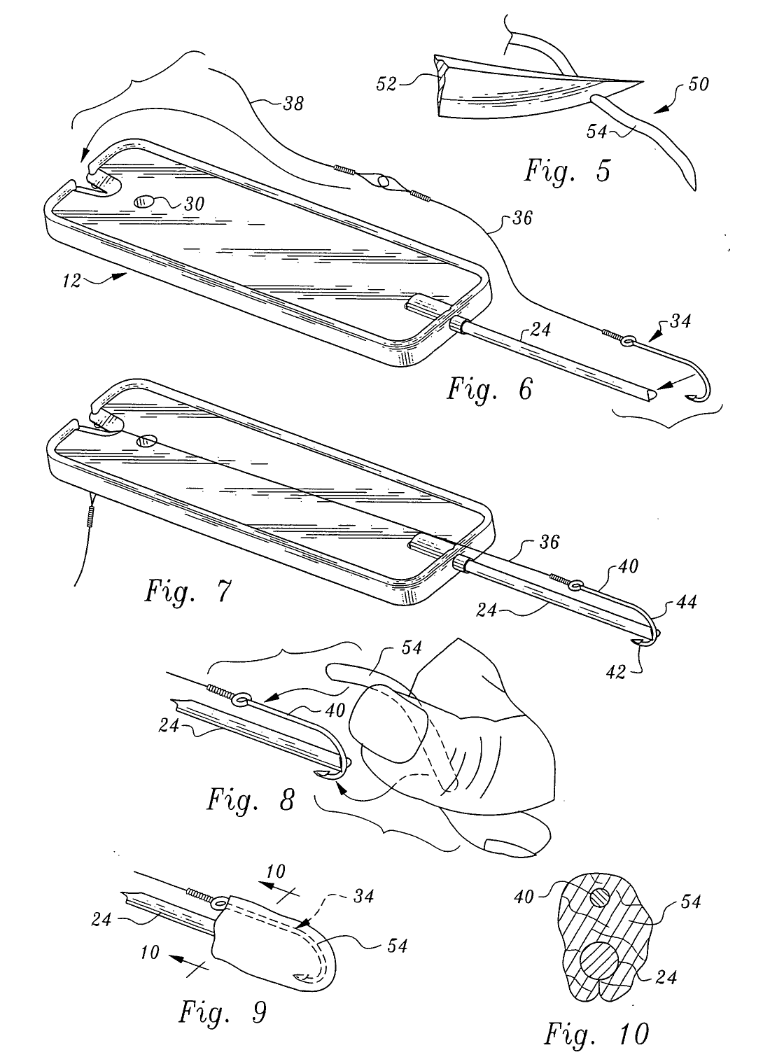

Now addressing the manner in which the device is used, reference is made to FIGS. 5-10 of the drawings. FIG. 6 illustrates the portions of conventional fishing equipment with which the device is intended to be used. Such portions include a hook 34, a leader 36, and a line 38. One end of the leader is attached to the main fishing line 38, and the other end of the leader is attached to the shank 40 of the hook. The distal end of the hook has a conventional barb 42, and intermediate the shank 40 and barb 42 is a conventional arcuate bend portion 44 resulting in the barb being generally parallel to the shank.

The bend portion of hook 34 is now placed in notch 28 of rod 24, and the leader 36 is then pulled through notch 26 and kept in a taut condition by maintaining tension on the leader. This will keep hook 34 seated against displacement in the rod notch 28. Assuming a worm 50 is to be used for live bait, the user can estimate the length of the hook 34, and if the worm length is substantially greater than the hook length, the worm can be severed by a knife 52 or manually torn to provide a worm section 54 of desired length. This worm section 54 is then manually placed on the hook shank 40 and the adjacent portion of the hook bend and pushed downwardly towards 24. Due to the nature of the body makeup of a worm, the worm section 54 will readily open around the shank 40, bend 44, and barb 42, completely encapsulating the same. Because the barb 42 is on the opposite side of rod 24 than shank 40, at least the distal end of rod 24 will also be encapsulated by the worm section 54, as illustrated in FIGS. 9 and 10 of the drawings.

The entire hook is now covered with the worm (or other bait material), and this is the desired end result. The user can now release tension on the leader, thereby releasing the hook from rod notch 28 and effectively separating the rod from the worm. The hook is now surrounded by worm tissue and is ready for attracting fish to bite such tissue which will result in the hook barb catching in the mouth of the fish.

1. A device for baiting a fish hook comprising a hand-engageable body portion having a length greater than its width, a rod extending longitudinally from one end of said body portion, said rod having a fish hook engaging notch at the distal end thereof, said body portion having a leader receiving notch remote from said one end.

2. The device of claim 1 in which said body portion is substantially flat and coplanar with said rod.

3. The device of claim 2 in which said body portion is substantially rectangular, said leader receiving notch being longitudinally aligned with said rod.

4. The device of claim 1 which is of a shape and material to permit the same to float in water.

5. The device of claim 1 in which said body portion has a bright colored exterior surface.

6. The device of claim 2 including an aperture extending through said body portion.

7. The device of claim 1 in which said body portion is formed of plastic.

8. The device of claim 7 in which said rod is formed of rust resistant metal.

9. A device for baiting a fish hook comprising a relatively flat hand engageable body portion of generally rectangular configuration with longitudinally extending sides and transversely extending ends, a rod lying in the plane of said body portion and extending longitudinally from a medial portion of one of said ends, the other end having a notch at a medial portion thereof and aligned with rod.

10. A method of baiting a fish hook comprising placing said hook in a notch, maintaining said hook in said notch by applying tension to a leader secured to said hook, urging a mass of bait over said hook and said notch to substantially encapsulate the hook, releasing said tension on said leader whereby said hook may be withdrawn from said notch with the bait on the hook.

11. The method of claim 10 in which said hook has a shank, a bend, and a barb, with said bend engaging said notch.

12. The method of claim 10 in which said leader is placed in a second notch remote from said hook engaging notch to maintain tension on said leader as bait is urged onto said hook.
